(19) United States
(12) Patent Application Publication
(10) Pub. No.: US 2026/0052213 A1
(43) Pub. Date: Feb. 19, 2026

(54) REFERENCE-LESS CROSS-MICROPHONE ECHO CANCELLATION

(71) Applicant: Cisco Technology, Inc., San Jose, CA (US)

(72) Inventors: Mahesh Godavarti, Cupertino, CA (US); Kamil Krzysztof Wojcicki, Kangaroo Point (AU)

(21) Appl. No.: 18/807,073

(22) Filed: Aug. 16, 2024

(51) Int. Cl. H04M 9/08; H04M 3/56

(52) U.S. Cl. CPC H04M 9/082; H04M 3/568

(57) ABSTRACT

A method is performed by an endpoint device that includes a microphone and a loudspeaker. The method comprises: muting the loudspeaker; participating in a conference session with a neighbor endpoint device that shares a space with the endpoint device; detecting audio in the space using the microphone to produce detected audio; determining whether audio distortion, originating at a neighbor loudspeaker of the neighbor endpoint device, is present or absent in the detected audio; and taking action to transmit the detected audio to the conference session, or not transmit the detected audio to the conference session to prevent echo, based on a result of the determining.

### TECHNICAL FIELD

The present disclosure relates generally to acoustic echo cancellation in a conference session that exchanges audio between devices.

### BACKGROUND

A conference arrangement may include multiple endpoints in a conference room connected to a conference session (e.g., an online meeting) and operated concurrently by corresponding participants. In this arrangement, audio emanating from a loudspeaker of a first endpoint leaks into a microphone of a second (neighboring) endpoint as well as into microphones of other neighboring endpoints. Canceling such leakage (as echo) with conventional linear acoustic echo cancellation (AEC) that employs locally generated reference signals at each endpoint is challenging because the echo (and reference signals) can have substantially differing time delays.

### BRIEF DESCRIPTION OF THE DRAWINGS

FIG. 1 shows a conference system in which reference-less cross-microphone echo cancellation techniques may be implemented, according to an example embodiment.

FIG. 2 shows a configuration of active and inactive local endpoints in a conference room and that may be used to implement the reference-less cross-microphone echo cancellation techniques, according to an example embodiment.

FIG. 3 is an illustration of the local endpoints that implement an example first embodiment of the reference-less cross-microphone echo cancellation techniques.

FIG. 4 is an illustration of the local endpoints that implement an example second embodiment of the reference-less cross-microphone echo cancellation techniques, according to an example embodiment.

FIG. 5 is an illustration of the local endpoints that implement an example third embodiment of the reference-less cross-microphone echo cancellation techniques.

FIG. 6 is an illustration of the local endpoints that implement an example fourth embodiment of the reference-less cross-microphone echo cancellation techniques.

FIG. 7 is an illustration of the local endpoints that implement an example fifth embodiment of the reference-less cross-microphone echo cancellation techniques.

FIG. 8 is an illustration of training an artificial intelligence (AI) or machine learning (ML) model that operates as an audio distortion detector, according to an embodiment.

FIG. 9 is an illustration of a No Reference (No-Ref) AEC module that implements features of the reference-less cross-microphone echo cancellation techniques, according to an embodiment.

FIG. 10 shows operations performed by an endpoint in connection with the reference-less cross-microphone echo cancellation techniques, according to an example embodiment.

FIG. 11 shows operations performed by an endpoint in connection with the reference-less cross-microphone echo cancellation techniques, according to another example embodiment.

FIG. 12 shows operations performed by an endpoint to implement the No-Ref AEC techniques, according to an yet another example embodiment.

FIG. 13 is a block diagram of a controller of an endpoint configured to perform various aspects of the reference-less cross-microphone echo cancellation techniques, according to an embodiment.

FIG. 14 illustrates a hardware block diagram of a computing device that may perform functions associated with operations of the reference-less cross-microphone echo cancellation techniques, according to an example embodiment.

### DETAILED DESCRIPTION

### Overview

In an embodiment, a method is performed by an endpoint device that includes a microphone and a loudspeaker. The method comprises: muting the loudspeaker; participating in a conference session with a neighbor endpoint device that shares a space with the endpoint device; detecting audio in the space using the microphone to produce detected audio; determining whether audio distortion, originating at a neighbor loudspeaker of the neighbor endpoint device, is present or absent in the detected audio; and taking action to transmit the detected audio to the conference session, or not transmit the detected audio to the conference session to prevent echo, based on a result of the determining.

### Example Embodiments

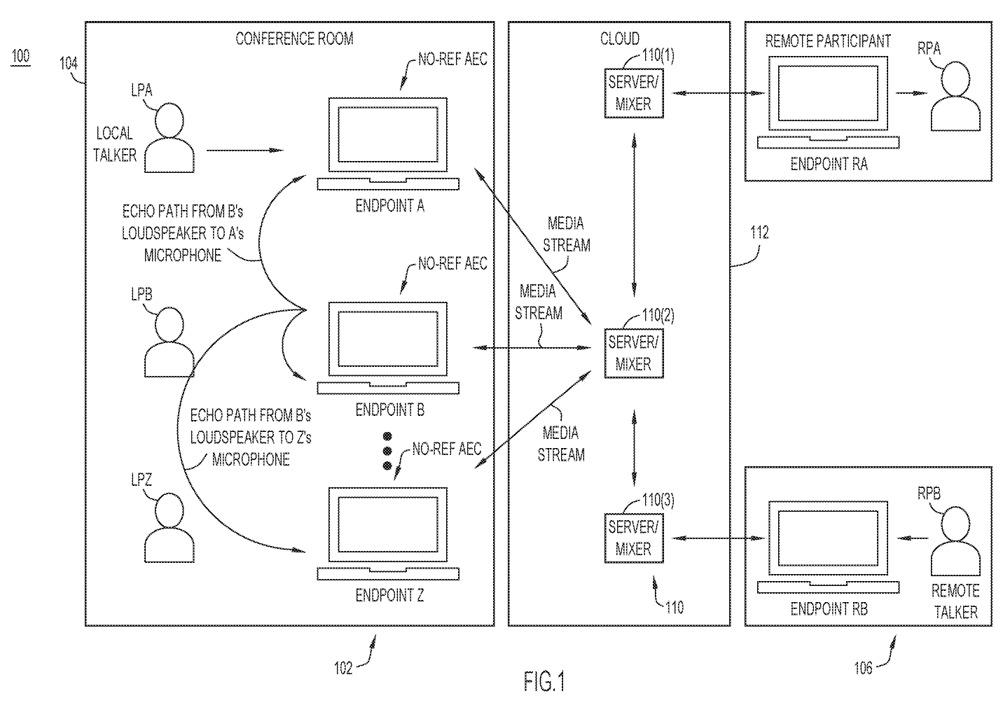

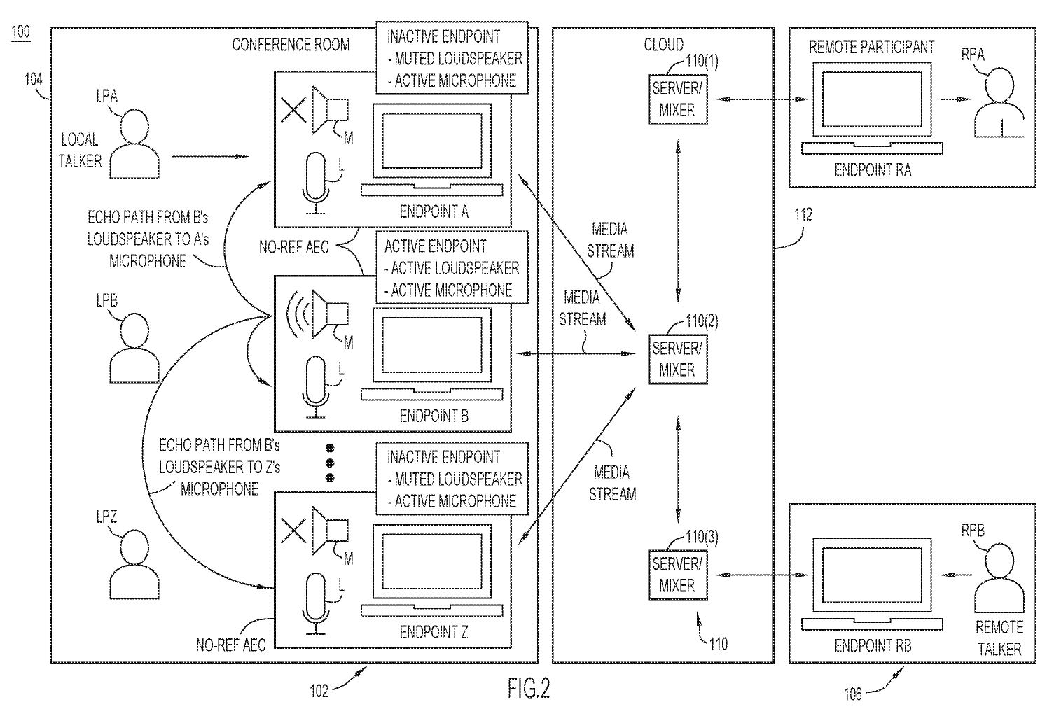

FIG. 1 shows an example conference system 100 in which embodiments directed to reference-less cross-microphone (mic) echo cancellation techniques may be implemented. Conference system 100 includes local endpoints A-Z (collectively referred to as “local endpoints 102”) operated by local participants LPA-LPZ and deployed in a spaced-apart arrangement across a physical space (referred to simply as a “space”), such as a room 104 or other shared space. Local endpoints 102 (and their local participants) are referred to as “local” because they are positioned in room 104. Conference system 100 also includes remote endpoints RA and RB (collectively referred to as “remote endpoints 106”) respectively operated by remote participants RPA and RPB. Remote endpoints 106 (and their remote participants) are referred to as “remote” because they are geographically separated from room 104. Each local and remote endpoint respectively includes audio devices in the form of a microphone and a loudspeaker (e.g., as shown in FIG. 2) to capture audio from, and play audio into, the environment in which the endpoint is deployed. The audio devices may be built-in, wirelessly connected, or both built-in and wirelessly connected to the endpoints. Non-limiting examples of endpoints include dedicated conference devices, personal computers, laptop computers, tablets, smartphones, and the like. In the ensuing description, the terms “endpoint” and “endpoint device” may be used interchangeably.

Conference system 100 further includes servers/mixers 110(1), 110(2) and 110(3) (collectively referred to as “servers/mixers 110”) hosted in a datacenter or cloud 112. Cloud 112 may be part of a network that includes one or more wide area networks (WANs), such as the Internet, and one or more local area networks (LANs) (not shown in FIG. 1). Local endpoints 102 and remote endpoints 106 connect to servers/mixers 110 and communicate with the servers/mixers (also referred to as “meeting servers”), and with each other, through cloud 112. Cloud 112 conveys traffic (e.g., data packets) between local endpoints 102, remote endpoints 106, and servers/mixers 110 using any known or hereafter developed communication protocols, such as the transmission control protocol (TCP)/Internet Protocol (IP), and the like.

Servers/mixers 110 manage online meetings (also referred to as “conference sessions”) between local endpoints 102 and remote endpoints 106. Servers/mixers 110 assist with establishing, maintaining, and terminating the conference sessions under control of the participants of the local and remote endpoints. FIG. 1 shows an example scenario in which servers/mixers 110 have established a conference session that concurrently connects local endpoints 102 to each other and to remote endpoints 106. The conference session supports simultaneous bi-directional media flows or streams between the endpoints. Each media stream may include data packets that convey multimedia, including audio, voice, video, text, graphics, and the like.

Continuing with the example scenario, remote participant RPB (referred to as a “remote talker”) talks into a microphone of remote endpoint RB (i.e., the remote talker utters “remote speech” into the microphone). The microphone of remote endpoint RB detects/captures the audio (referred to as “remote audio”) from the remote talker, and transmits the remote audio in parallel to local endpoints 102 over different paths that introduce different time delays. Local endpoints 102 receive the remote audio delivered by remote endpoint RB over the different paths with the different time delays. When received at each of local endpoints 102, the remote audio may be referred to as a “local copy” of the remote audio (also referred to as the “remote signal”). For example, local endpoints A and B respectively receive first and second local copies of the remote signal with first and second time delays.

Local endpoints 102 may playout respective local copies of the remote signal into room 104 through their respective loudspeakers. Focusing on local endpoint A and local endpoint B (which is a neighbor endpoint to local endpoint A), the loudspeaker of local endpoint B plays out into room 104 the local copy of the remote signal received by endpoint B. The local copy played out from the loudspeaker of local endpoint B leaks into the microphone of local endpoint A and represents “echo” at local endpoint A. For conventional linear AEC (also referred to as “reference-based AEC”) that employs conventional linear echo cancellation to remove echo that results from the echo leakage, an echo reference signal derived at local endpoint A based on the local copy of the remote signal received at local endpoint A should match (and be in time synchronization) with an audio echo reference signal derived at local endpoint B based on the local copy of the remote signal received at local endpoint B; however, the two echo reference signals differ (e.g., are time-shifted relative to each other) because the media streams transmitted by remote endpoint RB to local endpoints A and B may take different network paths. Hence, the audio echo reference signal derived at local endpoint A is typically ineffective at removing the echo originating from local endpoint B.

To avoid the challenges presented above, local endpoints 102 implement references-less cross-microphone echo cancellation (referred to as “No-Ref AEC” in short) to remove the echo. The No-Ref AEC removes echo that results from the above-described echo leakage without relying on conventional reference-based AEC. The No-Ref AEC distinguishes wanted or desired audio signals (e.g., speech to be retained) versus audio distortion (e.g., echo, background speech, reverberation, loudspeaker distortion, and so on, as defined below), which represents an unwanted or undesired audio signal to be suppressed, based on one or more of (a) a status or activity indicator of the loudspeaker of local endpoint B, and (b) a level of reverberation or loudspeaker distortion detected in room 104. When the status of the loudspeaker of endpoint B is active (i.e., the loudspeaker is actively playing audio into room 104), the No-Ref AEC assumes that reverberant audio detected from the room results from (i) the audio originating from that loudspeaker (i.e., that the reverberation is originating from the active loudspeaker) that can cause echo, or (ii) far-talker speech (i.e., background audio), and should be suppressed. In that case, the No-Ref AEC suppresses the audio, i.e., does not transmit the same to the remote endpoints. This removes the echo. Otherwise, the No-Ref AEC transmits the audio to the remote endpoints. Other features and advantages of the No-Ref AEC will be made apparent in the ensuing description.

FIG. 2 shows a configuration of active and inactive ones of local endpoints 102 that may be used with the No-Ref AEC, for example. An inactive endpoint is an endpoint that has (i) a muted loudspeaker L, which therefore does not play audio into room 104, and (ii) a microphone M that detects audio in the room to produce detected audio, and that provides the detected audio (also referred to as a “microphone signal”) to audio processing operations of the endpoint. On the other hand, an active endpoint does not mute its loudspeaker L, i.e., the loudspeaker is unmuted. Upon receiving a local copy of the remote signal described above, the active endpoint plays out the local copy through the (unmuted) loudspeaker L; the loudspeaker is considered active while playing out the local copy. In the example of FIG. 2, only local endpoint B is active, while all other local endpoints are inactive. Therefore, each inactive endpoint may detect echo leakage originating from the (active) loudspeaker L of local endpoint B while that loudspeaker plays out the local copy of the remote signal present in local endpoint B. Other examples may include more than one active local endpoint. A particular local endpoint can be active or inactive based on the configuration of, or the sequence of participation in, a conference. For example, local endpoint A can join the conference first and then local endpoint B can join the conference. In that case, local endpoint A is active and local endpoint B is inactive. On the other hand, when local endpoint B joins first and then local endpoint A joins, local endpoint B is active.

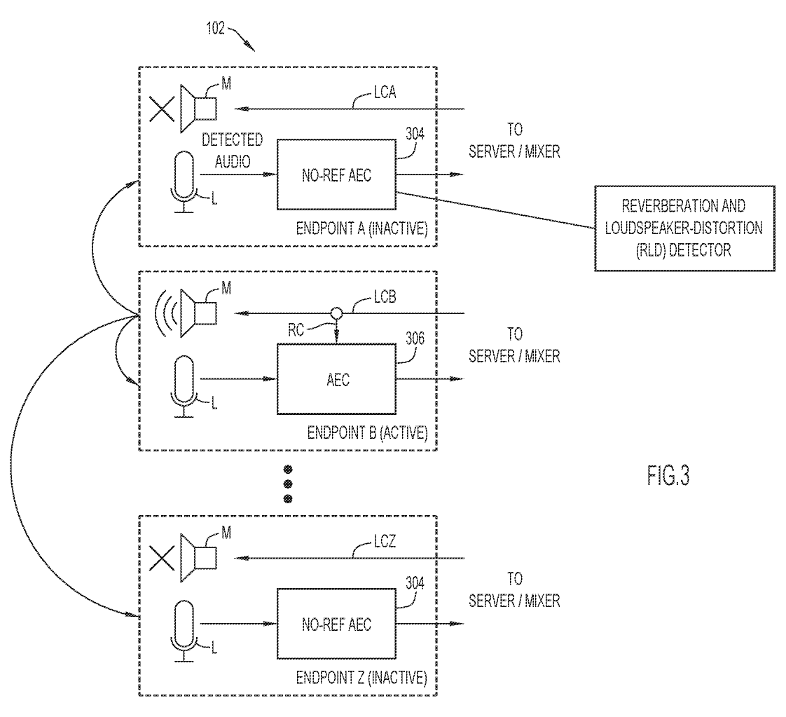

Multiple embodiments of the No-Ref AEC are described below in connection with FIGS. 3-7, which assume the inactive/active configuration of local endpoints 102 of FIG. 2. As will be described below, some embodiments of the No-Ref AEC have features that only reside in an inactive local endpoint. On the other hand, other embodiments of the No-Ref AEC have features that reside in both the inactive and an active local endpoint, and which cooperate to implement the No-Ref AEC across the two local endpoints. More generally, each local endpoint may be equipped with both the No-Ref AEC and conventional reference-based AEC. Then, depending on the active/inactive designation of a given local endpoint, features of the No-Ref AEC and/or the conventional reference-based AEC become operational, depending on the different embodiments described below. In one example, when a local endpoint is active, the reference-based AEC is operational on the local endpoint. Conversely, when the local endpoint is inactive, the No-Ref AEC is operational.

FIG. 3 is an illustration of local endpoints 102 that implement a first embodiment of the No-Ref AEC. The first embodiment of the No-Ref AEC is implemented in each local endpoint that is inactive (e.g., local endpoint A). To this end, each local endpoint that is inactive (e.g., local endpoint A) includes a local instance of a No Reference AEC (No-Ref AEC) module 304 and additional features to implement the first embodiment. On the other hand, local endpoint B that is active includes an AEC module 306 that implements conventional (reference-based) AEC. In FIG. 3, right arrows represent transmit paths/processing in the local endpoints, and left arrows represent receive paths/processing in the local endpoints. As shown, each local endpoint respectively includes a microphone M and a loudspeaker L.

In a receive direction, local endpoints A-Z respectively receive, record, and process local copies LCA-LCZ of a remote signal transmitted by remote endpoint RB, as described above in connection with FIG. 1. Each local endpoint that is inactive (e.g., local endpoint A) inhibits its loudspeaker L, and does not play its local copy (e.g., local copy LCA) into room 104. On the other hand, local endpoint B that is active plays into room 104 local copy LCB when present through its loudspeaker L in real-time.

In the example of FIG. 3, the audio present in room 104 at any given time may include (i) loudspeaker audio (which may include loudspeaker distortion) that originates from loudspeaker L of endpoint B, (ii) reverberation from room 104 that results from the loudspeaker audio and possibly from loud far-talker speech uttered by far talkers in the room (relative to microphone M of local endpoint B), and (iii) focusing on local endpoint A, near-talker speech uttered by local participant LPA, who represents a near talker with respect to local endpoint A.

At each local endpoint, microphone M detects the audio in room 104, and provides the detected audio to next stage audio processing, described below. The detected audio processing of each inactive local endpoint is similar. Accordingly, the ensuing description of detected audio processing in local endpoint A shall suffice for the other inactive local endpoints. Microphone M of local endpoint A provides the detected audio to No-Ref AEC module 304 of local endpoint A. No-Ref AEC module 304 implements, in part, a reverberation and loudspeaker-distortion (RLD) detector (also referred to as an “audio distortion detector”) that operates according to the No-Ref AEC. The RLD detector detects (in the detected audio) the presence of reverberation in room 104 and loudspeaker distortion that originates from loudspeaker L of local endpoint B.

Based on RLD detection decisions, No-Ref AEC module 304 takes action to transmit (i.e., pass) the detected audio to the conference session or not transmit the detected audio to the conference session (i.e., suppress the detected audio) to prevent echo. For example, when the RLD detector detects either reverberation or loudspeaker distortion, No-Ref AEC module 304 suppresses the detected audio from transmission to prevent echo. In that case, local endpoint A does not transmit the detected audio to remote endpoints 106. On the other hand, when the RLD detector does not detect at least one of reverberation or loudspeaker distortion, No-Ref AEC module 304 passes the detected audio to transmission. In that case, local endpoint A transmits the detected audio to remote endpoints 106.

In another example, the RLD detector may discriminate between (i) near-talker speech, and (ii) reverberation or loudspeaker distortion. When the RDL detector detects the near-talker speech, No-Ref AEC module 304 passes the detected audio. On the other hand, when the RLD detector detects either reverberation or loudspeaker distortion, No-Ref AEC module 304 suppresses the detected audio from transmission. When the RDL detector does not detect the near-talker speech and does not detect the reverberation (or loudspeaker distortion), No-Ref AEC module 304 suppresses the detected audio in one example, and passes the detected audio in another example.

In contrast to the inactive local endpoints, local endpoint B that is active includes AEC module 306 to implement conventional AEC. To that end, microphone M of local endpoint B provides detected audio to AEC module 306. Additionally, local endpoint B derives a reference copy RC of local copy LCB, and provides the same to AEC module 306. In turn, AEC module 306 cancels echo from the detected audio based on reference copy RC, to produce echo-canceled audio. Local endpoint B transmits the echo-canceled audio to remote endpoints 106.

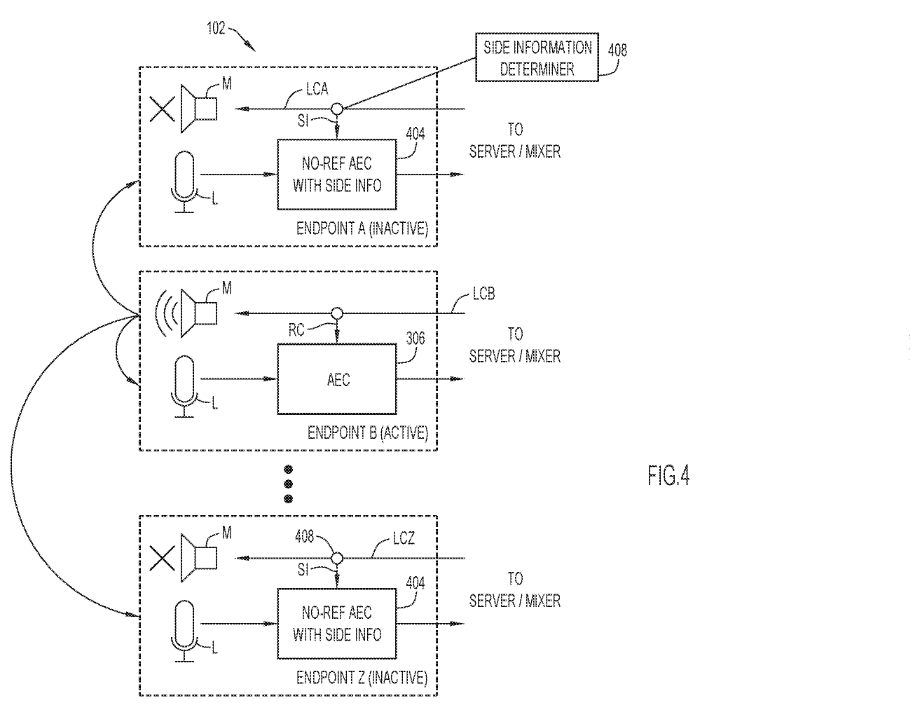

FIG. 4 is an illustration of local endpoints 102 that implement a second embodiment of the No-Ref AEC. The second embodiment is implemented in each inactive local endpoint (e.g., local endpoint A). To this end, each inactive local endpoint (e.g., local endpoint A) includes a local instance of a No-Ref AEC module 404 and other features to implement the second embodiment. No-Ref AEC module 404 is a slightly modified version of No-Ref AEC module 304 in that No-Ref AEC module 404 uses both detected audio from microphone M as well as side information. Inactive local endpoint B includes AEC module 306 to implement conventional AEC, as described above.

Audio processing performed in local endpoint A, in accordance with the second embodiment depicted in FIG. 4, is now described. Local endpoint A includes a side information determiner (SID) 408 in the receive path. SID 408 determines whether local copy LCA has been received/detected, and provides to No-Ref AEC module 404 side information SI (e.g., a signal) that indicates a result of the determination. In one example, SID 408 may determine that local copy LCA is present when a level of received audio energy/power exceeds a threshold, and is not present (i.e., is absent) when the level does not exceed the threshold. In another example, SID 408 may employ a voice activity detector (VAD) to detect the presence and absence of local copy LCA. Other techniques to detect the presence and absence may be used. When SID 408 detects the presence of local copy LCA, side information SI indicates the same (i.e., that local copy LCA is detected) to No-Ref AEC module 404 module. When SID 408 does not detect the presence of local copy LCA, side information SI indicates the same (i.e., that local copy LCA is not detected). As described above, local endpoint A is designated as inactive so its loudspeaker L is muted. Accordingly, loudspeaker L of local endpoint A does not play received local copy LCA (when present) into room 104.

No-Ref AEC module 404 of local endpoint A receives the detected audio from microphone M and side information SI from SID 408, and processes both inputs together. When the RLD detector of No-Ref AEC module 404 (i) detects either reverberation or loudspeaker distortion, and (ii) side information SI indicates the presence of local copy LCA within a predetermined time window of when the reverberation or the loudspeaker distortion is detected (e.g., within a temporal proximity time window of N milliseconds (ms)), the No-Ref AEC module suppresses the detected audio from transmission. On the other hand, when the RLD detector does not detect both the reverberation (or loudspeaker distortion) and the local copy of the LCA within the time window, No-Ref AEC module 404 passes the detected audio.

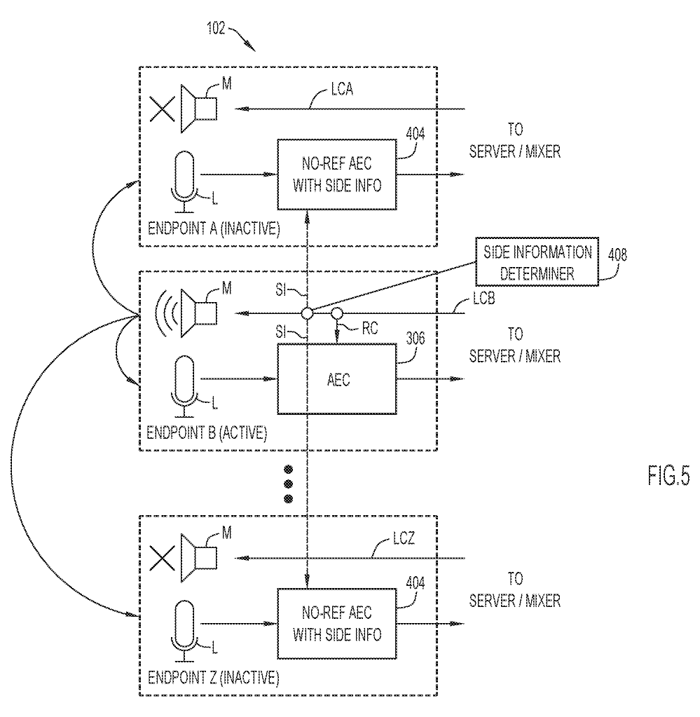

FIG. 5 is an illustration of local endpoints 102 that implement a third embodiment of the No-Ref AEC. The third embodiment involves features implemented in each inactive local endpoint (e.g., local endpoint A) as well as in active endpoint B, which cooperate to cancel echo in each inactive local endpoint. The third embodiment is similar to the second embodiment in that each inactive local endpoint retains No-Ref AEC module 404; however, in the third embodiment, SID 408 is moved to (active) local endpoint B. As shown, the receive path of endpoint B includes SID 408 to detect the presence or absence of local copy LCB, and to produce side information SI indicative of the result, as described above. Given that loudspeaker L of local endpoint B plays local copy LCB into room 104 when that local copy is present, and does not play that local copy when the local copy is absent, it follows that, in the third embodiment, side information SI also indicates whether loudspeaker L of endpoint B is active (i.e., actively playing/transmitting the local copy) or not active (i.e., not actively playing the local copy) at any given time. In other words, side information SI may alternatively provide (i) a first indication that local copy LCB is present and loudspeaker L of local endpoint B is active, or (ii) a second indication that local copy LCB is absent and loudspeaker L of local endpoint B is inactive.

Endpoint B transmits side information SI to each inactive local endpoint (e.g., local endpoint A) separately from the playback of audio through loudspeaker L of endpoint B. In an example, endpoint B may transmit side information SI to the inactive local endpoints wirelessly using any wireless technique, including, but not limited to, a radio frequency signal (such as, Bluetooth® wireless signals or Wi-Fi® wireless network signals, for example), ultrasound, and so on. Each inactive local endpoint that receives side information SI conveys the side information to the reverberation and loudspeaker-distortion detector of No-Ref AEC module 404, which operates as described above.

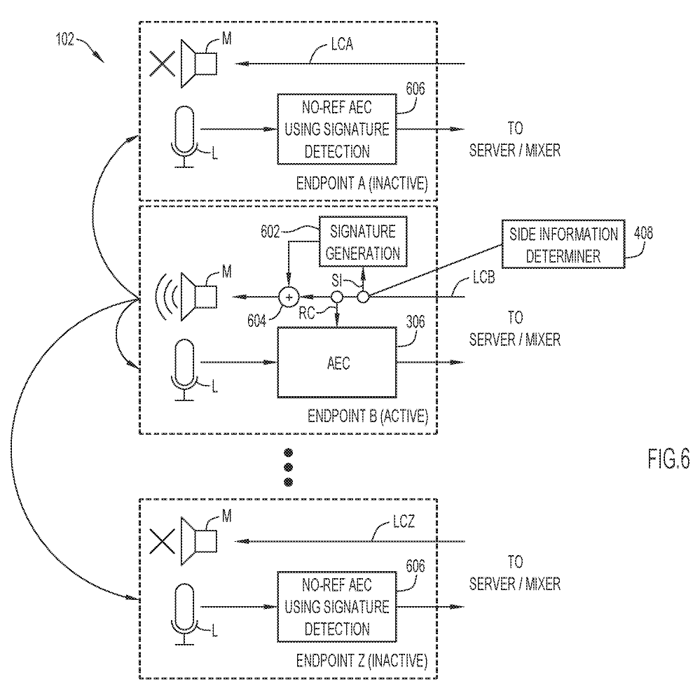

FIG. 6 is an illustration of local endpoints 102 that implement a fourth embodiment of the No-Ref AEC. The fourth embodiment includes features in each inactive local endpoint (e.g., local endpoint A) as well as active endpoint B, which cooperate to cancel echo in each inactive local endpoint. In the fourth embodiment, endpoint B includes a signature generator 602 and an adder 604 in addition to SID 408. In operation, SID 408 provides side information SI to signature generator 602. In turn, signature generator 602 generates an audio signature indicative of (i.e., that conveys) side information SI, and adder 604 inserts or embeds the audio signature into local copy LCB, to produce combined audio that includes local copy LCB and the audio signature.

Signature generator 602 and adder 604 may apply the audio signature in a time, frequency, embedding, or other domain via additive, convolutional, or other operations. The audio signature may be represented as an audio signal change (e.g., imperceptible notches at high frequencies to indicate echo presence), watermark, spread-spectrum type signal, and so on that is incorporated in local copy LCB with different characteristics depending on remote signal activity, and the like. The audio signature/watermark may be low pass filtered and spectrally balanced, for example. Endpoint B plays the combined audio (local copy LCB + audio signature) into room 104 through loudspeaker L of endpoint B.

Each inactive local endpoint includes a local instance of a No-Ref AEC module 606 configured to process detected audio that includes the audio signature (e.g., watermark embedded in the detected audio). For example, microphone M of local endpoint A provides to No-Ref AEC module 606 detected audio that includes the audio signature. No-Ref AEC module 606 recovers the audio signature from the detected audio, and recovers side information SI from the audio signature. No-Ref AEC module 606 then processes the detected audio along with side information SI in the same way that No-Ref AEC module 404 processes the detected audio along with side information SI.

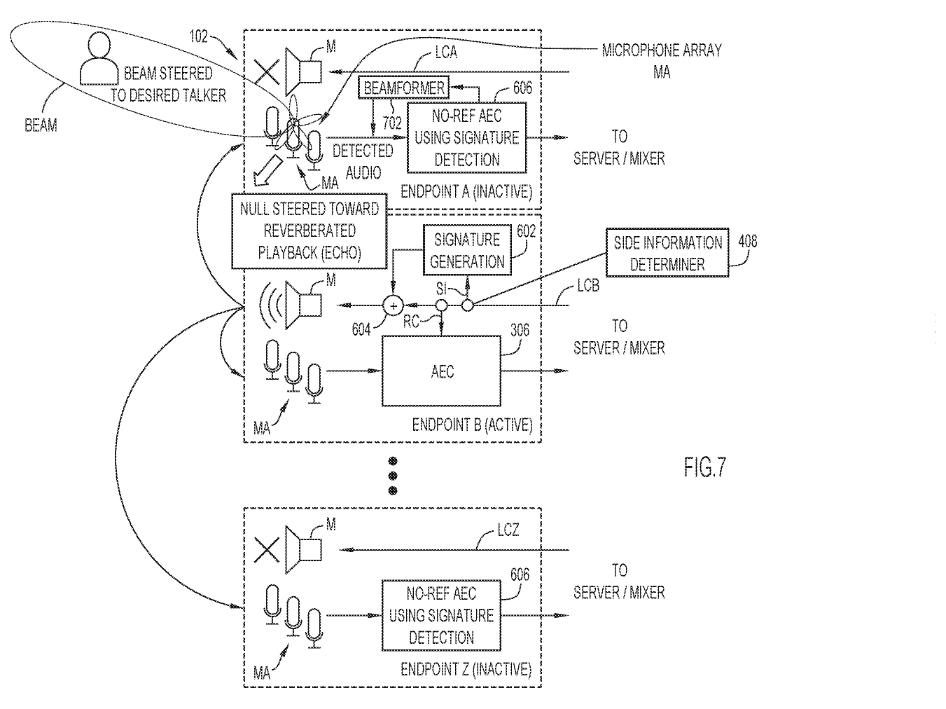

FIG. 7 is an illustration of local endpoints 102 in which a fifth embodiment of the No-Ref` AEC is implemented. The fifth embodiment is similar to the fourth embodiments with the addition of beam steering to cancel echo. Focusing on local endpoint A, the local endpoint includes a microphone array MA that can support audio beam steering under control of a beamformer 702 (also referred to as a “beam steerer”) that is coupled to the detected audio and No-Ref AEC module 606. Beamformer 702 performs acoustic beamforming on the detected audio from microphone array MA based on beamforming coefficients to form an acoustic receive beam at the microphone array. When No-Ref AEC module 606 contemporaneously detects reverberation/loudspeaker distortion and the audio signature (which indicates that loudspeaker L of endpoint B is active), beamformer 702 adapts the beamforming coefficients to point a null of the acoustic receive beam in a direction in which the reverberation/loudspeaker distortion is arriving at microphone array MA to suppress the distortion. Otherwise, local endpoint A passes the detected audio to transmission. In another example, the beamforming coefficients may be adapted to cause a high gain lobe of the beam to point towards a near talker.

The above-mentioned beam steering may also be applied to the configurations used for the first, second, and third embodiments.

The reverberation and loudspeaker-distortion detector (i.e., the audio distortion detector) may be implemented as an artificial intelligence (AI) detector that includes an AI model (e.g., a machine learning (ML) model) trained to detect audio distortion (including reverberation and loudspeaker distortion), and to discriminate or distinguish between the foregoing and other types of audio content, such as near-talker speech. In an example, the AI detector includes a deep learning model for processing audio. The deep learning model may be trained with inputs to include near-talker speech (which is desired speech) and audio distortion. The audio distortion can include (i) reverberated far-talker speech uttered by a far talker who is in a room with local endpoints but is far away from the local endpoints, and (ii) remote speech, uttered by a remote talker near a remote endpoint and played out into the room by an active local endpoint loudspeaker, and which is affected by loudspeaker distortion and reverberation. The loudspeaker playback of the remote speech may be convolved with a simulated echo path and optionally side information as described above. The deep learning model may also be trained with targets to include near-talker speech and/or suppressed echo.

Speech signals reproduced by a loudspeaker have varying degrees of distortions introduced by the loudspeaker. The distortions are known and can be characterized. The distortions include linear distortions, which may be influenced by a long term spectral shape/frequency response of the loudspeaker. The distortions also include non-linear distortions, such as saturation of the loudspeaker, level dependent response changes, and the like. Some distortion may be long-term stable, e.g., as with long term spectral shaping, while other distortion can be dynamic, and occur briefly, e.g., distortion at saturation points.

Natural speech can be differentiated from loudspeaker reproduced speech using the following operations. First, given a large corpus of training speech, noise, and reverberation, generate input mixtures for training of the AI model. The training speech includes varying degrees of convolved reverberation and added noise. Second, to half of the aforementioned examples, apply augmentation simulating the above-listed loudspeaker distortions. Third, using a training method A, train a binary classifier on the aforementioned examples, detect a presence (e.g., decision: 1) or an absence (e.g., decision: 0) of loudspeaker distortions. Fourth, using a training method B (in addition to, or as an alternative to, training method A), train a deep neural network (DNN) based speech enhancement model on the aforementioned examples to suppress loudspeaker speech but retain natural speech.

In another example, the AI model may be trained to produce a range of indicators/classifications of detected audio that include (i) at least one of reverberation and loudspeaker distortion is present or absent, (ii) reverberation is present or absent, (iii) loudspeaker distortion is present or absent, and (iv) near-talker speech is present or absent.

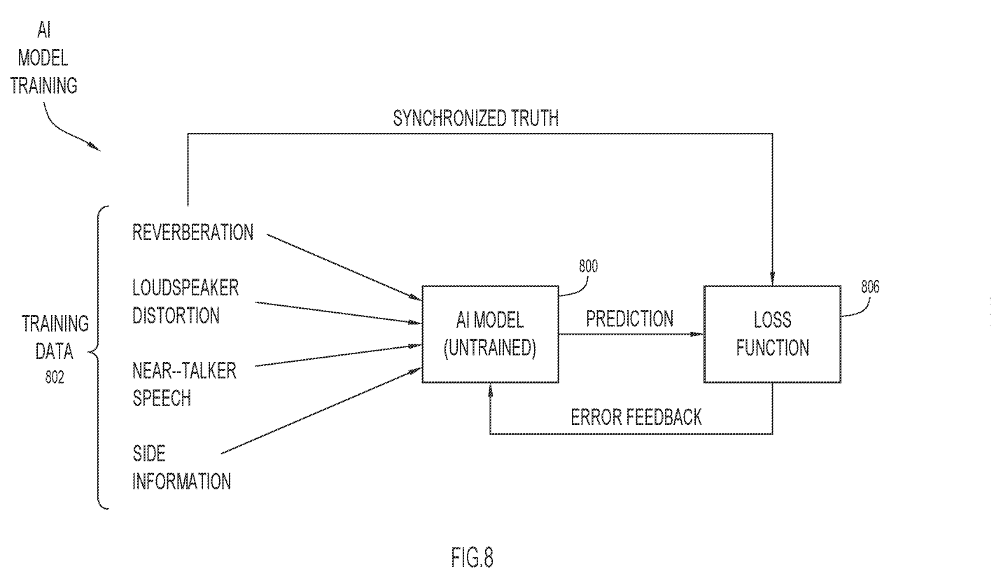

FIG. 8 is an illustration of example training of an AI model 800 that is initially untrained and that, when trained, will be used as an audio distortion (e.g., reverberation and loudspeaker-distortion) detector. The training applies to an audio input of AI model 800 example audio training data 802 representative of audio that includes near-talker speech (which is desired speech) and audio distortion which can include one or more of (i) reverberated far-talker speech, or (ii) remote speech affected by loudspeaker distortion and reverberation upon playback into a room by an active local endpoint, as described above. Each type of audio training data 802 also includes labels or “truth” that classifies the audio training data according to type. Depending on which No-Ref AEC embodiment is to be supported, audio training data 802 may also include side information, such as a flag to indicate a neighboring loudspeaker is actively transmitting audio, which may be introducing reverberation/loudspeaker distortion, for example.

The training also applies the truth to a loss function 806 so that the truth aligns with the type of audio training data 802 currently applied to AI model 800. That is, the truth is synchronized with the type of audio training data being input. AI model 800 predicts a classification of the type of audio (e.g., audio distortion, such as reverberation/loudspeaker distortion and near-talker speech, although expanded classifications are possible), and provides the prediction to loss function 806. In turn, loss function 806 compares the synchronized truth to the predicted classification, derives an error based on the compare (e.g., difference), and provides the error back to AI model 800 to adapt the AI model toward a more accurate predication in a next cycle.

In another training example, AI model 800 receives training audio that includes desired near-talker speech in addition to the audio distortion (as described above). AI model 800 model is trained to detect the audio distortion, and remove the same from the audio, leaving the desired near-talker speech available for transmission. The AI model 800 is trained to produce the remaining desired near-talker speech for transmission.

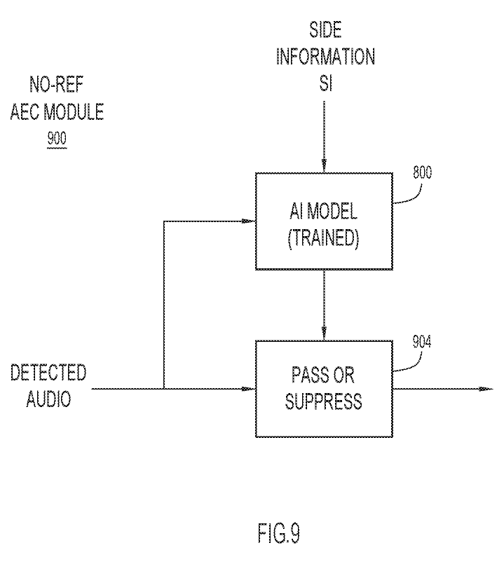

FIG. 9 is an illustration of a No-Ref AEC module 900, which may be used in the various embodiments described above. No-Ref AEC module 900 includes AI model 800 in a trained (inference) state and a pass/suppress module 904. AI model 800 and pass/suppress module 904 receive detected audio from microphone M. AI model 800 determines whether the detected audio includes audio distortion (e.g., reverberation or loudspeaker distortion), which may be a yes/no classification, and provides to pass/suppress module 904 an indicator of the result. Responsive to the indicator, pass/suppress module 904 either passes the detected audio to an output of the module (e.g., when the audio distortion is not present), or suppresses the detected audio (e.g., when the audio distortion is absent). This pass/suppress decision could be a time domain signal level, or may be made on a time-frequency (or other, e.g., embedding) basis using binary, real-valued, complex or other type of gain function.

In another arrangement that omits pass/suppress module 904, AI model 800 receives the detected audio to include desired near-talker speech in addition to audio distortion (as described above). As trained, AI model 800 detects the audio distortion, and removes the same from the audio, leaving the desired near-talker speech. AI model 800 passes only the desired near-talker speech to transmission.

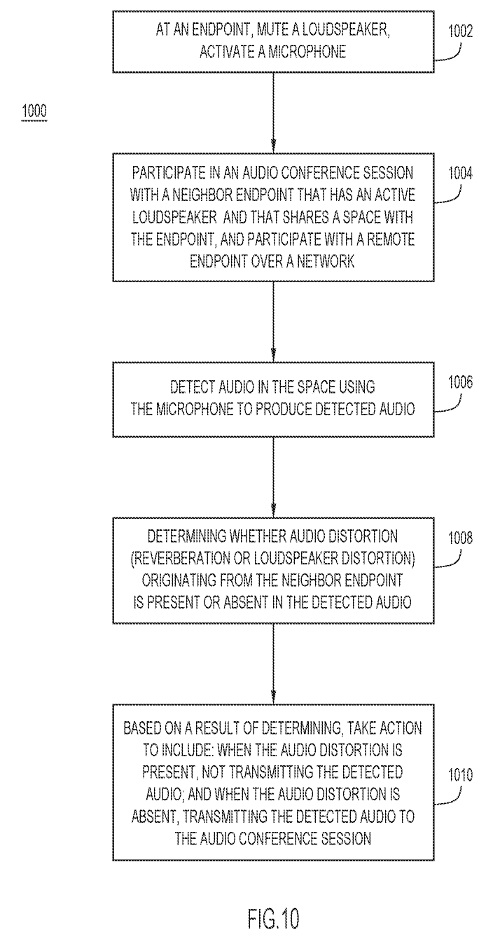

FIGS. 10, 11, and 12 described below show operations performed by an endpoint to implement reference-less cross-microphone echo cancellation (i.e., No-Ref AEC) in various embodiments. The operations are described above in various contexts. The operations may be reordered and interspersed with each other.

FIG. 10 shows operations 1000 performed by an endpoint to implement reference-less cross-microphone echo cancellation (i.e., No-Ref AEC), according to an embodiment. The endpoint is positioned in a space (e.g., an acoustic space, such as a conference room). The endpoint includes a microphone and a loudspeaker.

At 1002, the endpoint mutes its loudspeaker.

At 1004, the endpoint participates in a conference session with a neighbor endpoint that has a loudspeaker that is not muted (i.e., is active) and that shares the space with the endpoint. The endpoint may also participate in the conference session with a remote endpoint over a network. The conference session enables the endpoints to exchange audio with each other.

At 1006, the endpoint detects audio in the space using the microphone to produce detected audio.

At 1008, the endpoint determines whether audio distortion (e.g., reverberation or loudspeaker distortion in the room), originating at a neighbor loudspeaker of the neighbor endpoint, is present or absent in the detected audio.

At 1010, the endpoint takes action based on a result of the determining at 1008. The action includes, when the audio distortion is present, not transmitting the detected audio to the conference session to avoid echo. Alternatively, the action includes, when the audio distortion is absent, transmitting the detected audio to the conference session.

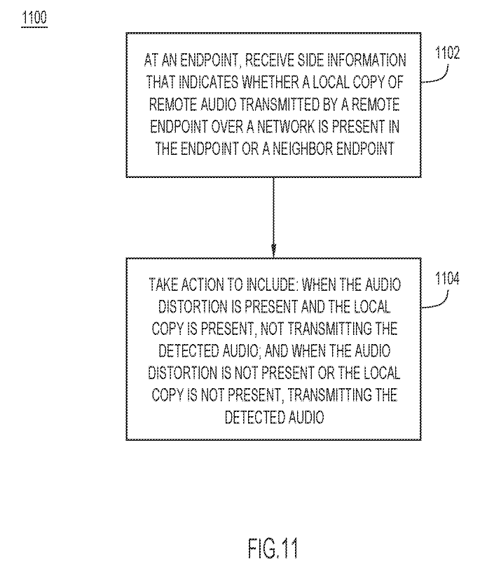

FIG. 11 shows operations 1100 performed by the endpoint to implement the No-Ref AEC, according to another embodiment. It is assumed that the endpoint performs operations 1002-1008.

At 1102, the endpoint receives side information that indicates whether a local copy of remote audio transmitted by the remote endpoint over the network is present in the endpoint or in the neighbor endpoint. In one example, the endpoint determines whether the local copy is present in the endpoint, and then generates the side information. In another embodiment, the neighbor endpoint determines whether the local copy is present in the neighbor endpoint (which means the neighbor endpoint is actively playing that local copy via its loudspeaker), generates the side information (which also indicates whether the neighbor endpoint loudspeaker is actively playing that local copy), and transmits the side information to the endpoint (which receives the side information).

At 1104, the endpoint takes the following actions. When the audio distortion is present and the local copy is present, the endpoint does not transmit the detected audio to the conference. Alternatively, when the audio distortion is not present or the local copy is not present, the endpoint transmits the detected audio to the conference.

In addition, the endpoint may determine whether the audio distortion and the local copy are both present within a predetermined time window. When the audio distortion and the local copy are both present within the predetermined time window, the endpoint does not transmit the detected audio to the conference. Otherwise the endpoint does transmit the detected audio conference.

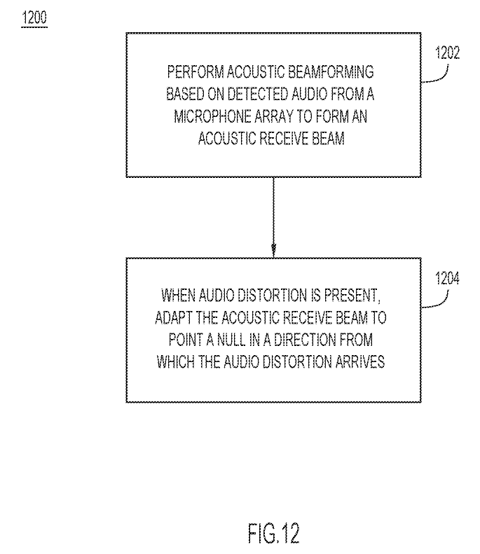

FIG. 12 shows operations 1200 performed by the endpoint to implement the No-Ref AEC, according to yet another embodiment. The endpoint includes a microphone array to produce detected audio.

At 1202, the endpoint performs acoustic beamforming based on the detected audio to form an acoustic receive beam at the microphone array.

At 1204, when audio distortion is present (as detected at 1008), the endpoint adapts the acoustic receive beam to point a null in a direction from which the audio distortion arrives at the microphone array.

In summary, embodiments presented herein mitigate cross-mic echo cancellation in a multi-client conferencing solution in which conference call participants operate/use their own endpoints (with respective microphones and loudspeakers). The embodiments exploit the fact that speech emanating from a participant positioned at his/her own endpoint may be "reverberation free" as opposed to the cross-mic echo emanating from a loudspeaker of a neighboring endpoint. The embodiments distinguish wanted signals (e.g., speech to be retained) versus unwanted signals (e.g., echo and/or background speech to be suppressed) based on (a) status (activity) of a loudspeaker of a neighbor endpoint, and (b) a level of reverberation. The embodiments assume that when the loudspeaker of the neighbor endpoint is active, the reverberant speech is either echo or far (background) talker speech, and block or remove the reverberant speech. An advantage of the embodiments is that echo is removed without the use of matching acoustic reference signals between endpoints. Thus, varying delay between such reference signals does not impact the performance of the embodiments. Some embodiments may rely on a flag to indicate that a neighbor loudspeaker is active in an immediate temporal vicinity of reverberant speech being detected. Also, the embodiments operate without conventional linear filtering AEC and the processing and memory burdens imposed by the same. Other variations include using reverberation to improve the performance of microphone array based echo cancellation speakerphones. In such variations, signals from each microphone array are fed into a filter array with a single output. The presence and absence of reverberation are used to control the adaptation of filter array coefficients. The adaptation is performed whenever reverberation is detected in the microphone signal so that the output of the filter array is zero whenever reverberation is high.

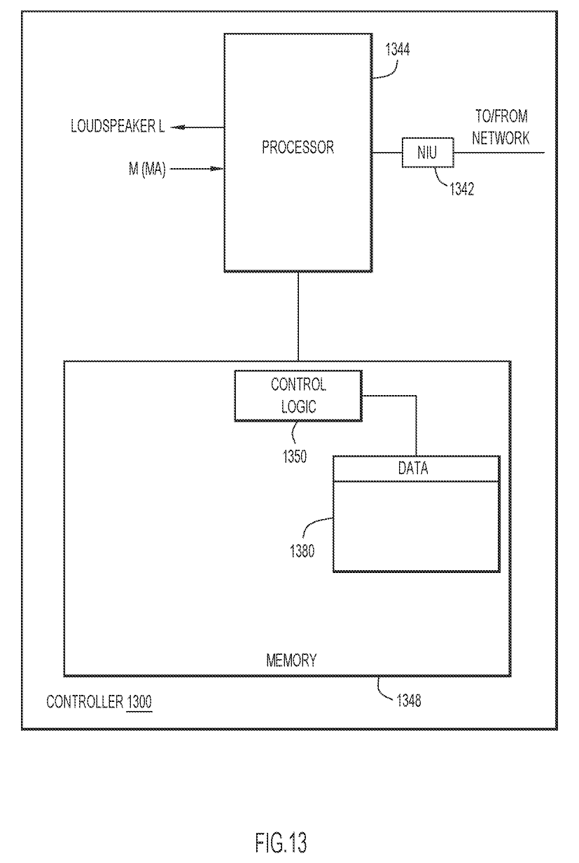

Reference is now made to FIG. 13, which is a block diagram of an example controller 1300 of any of local endpoints 102 or remote endpoints 106. There are numerous possible configurations for controller 1300 and FIG. 13 is meant to be an example. Controller 1300 includes a network interface unit 1342, a processor 1344, and memory 1348. The aforementioned components of controller 1300 may be implemented in hardware, software, firmware, and/or a combination thereof. The network interface (I/F) unit (NIU) 1342 is, for example, an Ethernet card or other interface device that allows the controller 1300 to communicate over a network (e.g., with cloud 112). Network I/F unit 1342 may include wired and/or wireless connection capability.

Processor 1344 may include a collection of microcontrollers and/or microprocessors, for example, each configured to execute respective software instructions stored in the memory 1348. The collection of microcontrollers may include, for example: an audio processor to receive, send, and process audio signals related to loudspeaker L and microphone M (or microphone array MA); and a high-level controller to provide overall control. Portions of memory 1348 (and the instructions therein) may be integrated with processor 1344. In the transmit direction, processor 1344 processes audio captured by microphone M (e.g., detected audio), encodes the captured audio into data packets using audio codecs, and causes the encoded data packets to be transmitted to the cloud. In the receive direction, processor 1344 decodes audio from data packets received from the cloud and causes the audio to be presented to participants via loudspeaker L. As used herein, the terms “audio” and “sound” are synonymous and used interchangeably. Also, “voice” and “speech” are synonymous and used interchangeably.

The memory 1348 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 1348 may comprise one or more computer readable storage media (e.g., a memory device) encoded with software comprising computer executable instructions and when the software is executed (by the processor 1344) it is operable to perform the operations described herein. For example, the memory 1348 stores or is encoded with instructions for control logic 1350 perform operations described herein.

Control logic 1350 includes logic to process the detected audio/microphone signals In addition, memory 1348 stores data 1380 used and generated by control logic 1350.

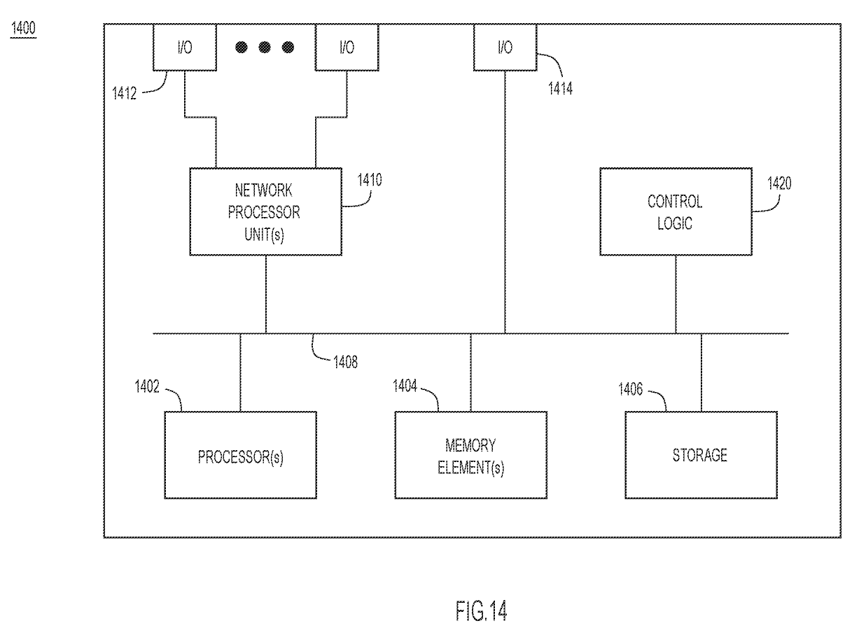

Referring to FIG. 14, FIG. 14 illustrates a hardware block diagram of a computing device 1400 that may perform functions associated with operations discussed herein in connection with the techniques depicted in FIGS. 1-13. In various embodiments, a computing device or apparatus, such as computing device 1400 or any combination of computing devices 1400, may be configured as any entity/entities as discussed for the techniques depicted in connection with FIGS. 1-13 in order to perform operations of the various techniques discussed herein. For example, computing device 1400 may represent any of local endpoints 102 and remote endpoints 106, controller 1300, and so on.

In at least one embodiment, the computing device 1400 may be any apparatus that may include one or more processor(s) 1402, one or more memory element(s) 1404, storage 1406, a bus 1408, one or more network processor unit(s) 1410 interconnected with one or more network input/output (I/O) interface(s) 1412, one or more I/O interface(s) 1414, and control logic 1420. In various embodiments, instructions associated with logic for computing device 1400 can overlap in any manner and are not limited to the specific allocation of instructions and/or operations described herein.

In at least one embodiment, processor(s) 1402 is/are at least one hardware processor configured to execute various tasks, operations and/or functions for computing device 1400 as described herein according to software and/or instructions configured for computing device 1400. Processor(s) 1402 (e.g., a hardware processor) can execute any type of instructions associated with data to achieve the operations detailed herein. In one example, processor(s) 1402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 1404 and/or storage 1406 is/are configured to store data, information, software, and/or instructions associated with computing device 1400, and/or logic configured for memory element(s) 1404 and/or storage 1406. For example, any logic described herein (e.g., control logic 1420) can, in various embodiments, be stored for computing device 1400 using any combination of memory element(s) 1404 and/or storage 1406. Note that in some embodiments, storage 1406 can be consolidated with memory element(s) 1404 (or vice versa), or can overlap/exist in any other suitable manner.

In at least one embodiment, bus 1408 can be configured as an interface that enables one or more elements of computing device 1400 to communicate in order to exchange information and/or data. Bus 1408 can be implemented with any architecture designed for passing control, data and/or information between processors, memory elements/storage, peripheral devices, and/or any other hardware and/or software components that may be configured for computing device 1400. In at least one embodiment, bus 1408 may be implemented as a fast kernel-hosted interconnect, potentially using shared memory between processes (e.g., logic), which can enable efficient communication paths between the processes.

In various embodiments, network processor unit(s) 1410 may enable communication between computing device 1400 and other systems, entities, etc., via network I/O interface(s) 1412 (wired and/or wireless) to facilitate operations discussed for various embodiments described herein. In various embodiments, network processor unit(s) 1410 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 1400 and other systems, entities, etc. to facilitate operations for various embodiments described herein. In various embodiments, network I/O interface(s) 1412 can be configured as one or more Ethernet port(s), Fibre Channel ports, any other I/O port(s), and/or antenna(s)/antenna array(s) now known or hereafter developed. Thus, the network processor unit(s) 1410 and/or network I/O interface(s) 1412 may include suitable interfaces for receiving, transmitting, and/or otherwise communicating data and/or information in a network environment.

I/O interface(s) 1414 allow for input and output of data and/or information with other entities that may be connected to computing device 1400. For example, I/O interface(s) 1414 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1420 can include instructions that, when executed, cause processor(s) 1402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1404 and/or storage 1406 can store data, software, code, instructions (e.g., processor instructions), logic, parameters, combinations thereof, and/or the like used for operations described herein. This includes memory element(s) 1404 and/or storage 1406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In some aspects, the techniques described herein relate to a method performed by an endpoint device that includes a microphone and a loudspeaker, the method including: muting the loudspeaker; participating in a conference session with a neighbor endpoint device that shares a space with the endpoint device; detecting audio in the space using the microphone to produce detected audio; determining whether audio distortion, originating at a neighbor loudspeaker of the neighbor endpoint device, is present or absent in the detected audio; and taking action to transmit the detected audio to the conference session, or not transmit the detected audio to the conference session to prevent echo, based on a result of the determining.

In some aspects, the techniques described herein relate to a method, wherein taking the action includes: when the audio distortion is present, not transmitting the detected audio to the conference session; and when the audio distortion is absent, transmitting the detected audio to the conference session.

In some aspects, the techniques described herein relate to a method, wherein the determining includes determining whether reverberation or loudspeaker distortion originating at the neighbor loudspeaker is present or absent.

In some aspects, the techniques described herein relate to a method, wherein the determining includes using an artificial intelligence model trained to distinguish the audio distortion from other types of audio content.

In some aspects, the techniques described herein relate to a method, wherein: the audio includes desired near-talker speech in addition to the audio distortion; the artificial intelligence model is further trained to remove the audio distortion from the audio, leaving the desired near-talker speech; and the taking action includes transmitting only the desired near-talker speech.

In some aspects, the techniques described herein relate to a method, wherein the participating includes participating in the conference session with a remote endpoint device over a network, and the method further includes, at the endpoint device: receiving side information that indicates whether a local copy of remote audio transmitted by the remote endpoint device over the network is present in the endpoint device or the neighbor endpoint device, wherein the taking action includes: when the audio distortion is present and the local copy is present, not transmitting the detected audio; and when the audio distortion is not present or the local copy is not present, transmitting the detected audio.

In some aspects, the techniques described herein relate to a method, further including, at the endpoint device: determining whether the audio distortion and the local copy are both present within a predetermined time window, wherein the taking action includes, when the audio distortion and the local copy are both present within the predetermined time window, not transmitting the detected audio.

In some aspects, the techniques described herein relate to a method, further including, at the endpoint device: generating the side information such that the side information indicates whether the local copy of the remote audio is present in the endpoint device.

In some aspects, the techniques described herein relate to a method, wherein the receiving includes receiving, from the neighbor endpoint device, the side information such that the side information indicates whether the local copy of the remote audio is present in the neighbor endpoint device and that the neighbor loudspeaker of the neighbor endpoint device is actively playing the local copy into the space.

In some aspects, the techniques described herein relate to a method, wherein the receiving the side information includes receiving the side information wirelessly via a radio frequency signal or an ultrasound signal.

In some aspects, the techniques described herein relate to a method, wherein the receiving the side information includes receiving the side information via an acoustic watermark embedded in the detected audio.

In some aspects, the techniques described herein relate to a method, wherein the microphone includes a microphone array, and the method further includes: performing acoustic beamforming based on the detected audio to form an acoustic receive beam at the microphone array; and when the audio distortion is present, adapting the acoustic receive beam to point a null in a direction from which the audio distortion arrives at the microphone array.

In some aspects, the techniques described herein relate to an apparatus including: a network interface to communicate with a network; a microphone to detect audio in a local space to produce detected audio; a loudspeaker; and a processor coupled to the network interface, the microphone, and the loudspeaker and configured to perform: participating in a conference session with a neighbor endpoint device positioned in the local space with the apparatus; muting the loudspeaker; receiving the detected audio; determining whether audio distortion originated at a neighbor loudspeaker of the neighbor endpoint device is present or absent in the detected audio; and taking action to transmit the detected audio to the conference session, or not transmit the detected audio to the conference session to prevent echo, based on results of the determining.

In some aspects, the techniques described herein relate to an apparatus, wherein the processor is configured to perform taking action by: when the audio distortion is present, not transmitting the detected audio to the conference session; and when the audio distortion is absent, transmitting the detected audio to the conference session.

In some aspects, the techniques described herein relate to an apparatus, wherein the processor is configured to perform the determining by determining whether reverberation originating at the neighbor loudspeaker or loudspeaker distortion originating at the neighbor loudspeaker is present or absent.

In some aspects, the techniques described herein relate to an apparatus, wherein the processor is configured to perform the participating by participating in the conference session with a remote endpoint device over the network, and the processor is further configured to perform: receiving side information that indicates whether a local copy of remote audio transmitted by the remote endpoint device over the network is present in the apparatus or the neighbor endpoint device, wherein taking action includes: when the audio distortion is present and the local copy is present, not transmitting the detected audio; and when the audio distortion is not present or the local copy is not present, transmitting the detected audio.

In some aspects, the techniques described herein relate to an apparatus, wherein the processor is further configured to perform: determining whether the audio distortion and the local copy are both present within a predetermined time window, wherein taking action includes, when the audio distortion and the local copy are both present within the predetermined time window, not transmitting the detected audio.

In some aspects, the techniques described herein relate to a non-transitory computer readable medium encoded with instructions that, when executed by a processor of an endpoint device that includes a microphone and a loudspeaker, cause the processor to perform: muting the loudspeaker; participating in a conference session with a neighbor endpoint device that shares a space with the endpoint device; receiving, from the microphone, detected audio that represents audio in the space; determining whether audio distortion, originating at a neighbor loudspeaker of the neighbor endpoint device, is present or absent in the detected audio; and taking action to transmit the detected audio to the conference session, or not transmit the detected audio to the conference session to prevent echo, based on a result of the determining.

In some aspects, the techniques described herein relate to a non-transitory computer readable medium, wherein taking action includes: when the audio distortion is present, not transmitting the detected audio to the conference session; and when the audio distortion is absent, transmitting the detected audio to the conference session.

In some aspects, the techniques described herein relate to a non-transitory computer readable medium, wherein the determining includes determining whether reverberation originating at the neighbor loudspeaker or loudspeaker distortion originating at the neighbor loudspeaker is present or absent.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by an endpoint device that includes a microphone and a loudspeaker, the method comprising:
muting the loudspeaker;
participating in a conference session with a neighbor endpoint device that shares a space with the endpoint device;
detecting audio in the space using the microphone to produce detected audio;
determining whether audio distortion, originating at a neighbor loudspeaker of the neighbor endpoint device, is present or absent in the detected audio; and
taking action to transmit the detected audio to the conference session, or not transmit the detected audio to the conference session to prevent echo, based on a result of the determining.

2. The method of claim 1, wherein taking the action includes:
when the audio distortion is present, not transmitting the detected audio to the conference session; and
when the audio distortion is absent, transmitting the detected audio to the conference session.

3. The method of claim 1, wherein the determining includes determining whether reverberation or loudspeaker distortion originating at the neighbor loudspeaker is present or absent.

4. The method of claim 1, wherein the determining includes using an artificial intelligence model trained to distinguish the audio distortion from other types of audio content.

5. The method of claim 4, wherein:
the audio includes desired near-talker speech in addition to the audio distortion;
the artificial intelligence model is further trained to remove the audio distortion from the audio, leaving the desired near-talker speech; and
the taking action includes transmitting only the desired near-talker speech.

6. The method of claim 1, wherein the participating includes participating in the conference session with a remote endpoint device over a network, and the method further comprises, at the endpoint device:
receiving side information that indicates whether a local copy of remote audio transmitted by the remote endpoint device over the network is present in the endpoint device or the neighbor endpoint device,
wherein the taking action includes:
when the audio distortion is present and the local copy is present, not transmitting the detected audio; and
when the audio distortion is not present or the local copy is not present, transmitting the detected audio.

7. The method of claim 6, further comprising, at the endpoint device:
determining whether the audio distortion and the local copy are both present within a predetermined time window,
wherein the taking action includes, when the audio distortion and the local copy are both present within the predetermined time window, not transmitting the detected audio.

8. The method of claim 6, further comprising, at the endpoint device:
generating the side information such that the side information indicates whether the local copy of the remote audio is present in the endpoint device.

9. The method of claim 6, wherein the receiving includes receiving, from the neighbor endpoint device, the side information such that the side information indicates whether the local copy of the remote audio is present in the neighbor endpoint device and that the neighbor loudspeaker of the neighbor endpoint device is actively playing the local copy into the space.

10. The method of claim 9, wherein the receiving the side information includes receiving the side information wirelessly via a radio frequency signal or an ultrasound signal.

11. The method of claim 9, wherein the receiving the side information includes receiving the side information via an acoustic watermark embedded in the detected audio.

12. The method of claim 1, wherein the microphone includes a microphone array, and the method further comprises:
performing acoustic beamforming based on the detected audio to form an acoustic receive beam at the microphone array; and
when the audio distortion is present, adapting the acoustic receive beam to point a null in a direction from which the audio distortion arrives at the microphone array.

13. An apparatus comprising:
a network interface to communicate with a network;
a microphone to detect audio in a local space to produce detected audio;
a loudspeaker; and
a processor coupled to the network interface, the microphone, and the loudspeaker and configured to perform:
participating in a conference session with a neighbor endpoint device positioned in the local space with the apparatus;
muting the loudspeaker;
receiving the detected audio;
determining whether audio distortion originated at a neighbor loudspeaker of the neighbor endpoint device is present or absent in the detected audio; and
taking action to transmit the detected audio to the conference session, or not transmit the detected audio to the conference session to prevent echo, based on results of the determining.

14. The apparatus of claim 13, wherein the processor is configured to perform taking action by:
when the audio distortion is present, not transmitting the detected audio to the conference session; and
when the audio distortion is absent, transmitting the detected audio to the conference session.

15. The apparatus of claim 13, wherein the processor is configured to perform the determining by determining whether reverberation originating at the neighbor loudspeaker or loudspeaker distortion originating at the neighbor loudspeaker is present or absent.

16. The apparatus of claim 13, wherein the processor is configured to perform the participating by participating in the conference session with a remote endpoint device over the network, and the processor is further configured to perform:
receiving side information that indicates whether a local copy of remote audio transmitted by the remote endpoint device over the network is present in the apparatus or the neighbor endpoint device,
wherein taking action includes:
when the audio distortion is present and the local copy is present, not transmitting the detected audio; and
when the audio distortion is not present or the local copy is not present, transmitting the detected audio.

17. The apparatus of claim 16, wherein the processor is further configured to perform:
determining whether the audio distortion and the local copy are both present within a predetermined time window,
wherein taking action includes, when the audio distortion and the local copy are both present within the predetermined time window, not transmitting the detected audio.

18. A non-transitory computer readable medium encoded with instructions that, when executed by a processor of an endpoint device that includes a microphone and a loudspeaker, cause the processor to perform:
muting the loudspeaker;
participating in a conference session with a neighbor endpoint device that shares a space with the endpoint device;
receiving, from the microphone, detected audio that represents audio in the space;
determining whether audio distortion, originating at a neighbor loudspeaker of the neighbor endpoint device, is present or absent in the detected audio; and
taking action to transmit the detected audio to the conference session, or not transmit the detected audio to the conference session to prevent echo, based on a result of the determining.

19. The non-transitory computer readable medium of claim 18, wherein taking action includes:
when the audio distortion is present, not transmitting the detected audio to the conference session; and
when the audio distortion is absent, transmitting the detected audio to the conference session.

20. The non-transitory computer readable medium of claim 18, wherein the determining includes determining whether reverberation originating at the neighbor loudspeaker or loudspeaker distortion originating at the neighbor loudspeaker is present or absent.
